(19) United States
(12) Patent Application Publication
(10) Pub. No.: US 2026/0279752 A1
(43) Pub. Date: Sep. 17, 2026

(54) Systems and Methods for Auto-Generation of Ion List

(71) Applicant: DH Technologies Development Pte. Ltd., Singapore (SG)

(72) Inventors: Gordana IVOSEV, Etobicoke (CA); Chang LIU, Richmond HIll (CA)

(21) Appl. No.: 19/166,937

(22) PCT Filed: Mar. 19, 2024
(86) PCT No.: PCT/IB2024/052651

§ 371 Date: Sep. 19, 2025

Related U.S. Application Data
(60) Provisional application No. 63/491,515, filed on Mar. 21, 2023.

(51) Int. Cl. H01J 49/00

(52) U.S. Cl. CPC H01J 49/0036

(57) ABSTRACT

A method for determining a composition of a sample utilizing mass spectrometry includes introducing a plurality of sample ions, obtaining a plurality of mass spectra including a sample introduction mass spectrum associated with the sample introduction event, identifying a set of background signals, identifying a set of sample ion signals by removing background ions, and deriving, from the set of sample ion signals, an ion list corresponding to the composition of the sample.

### RELATED APPLICATIONS

This application claims priority to U.S. Provisional Application No. 63/491,515 filed on Mar. 21, 2023, the contents of which are incorporated herein in their entirety.

### TECHNICAL FIELD

The present disclosure relates to methods and systems for performing mass spectrometry and more particularly to generating ion lists using high throughput mass spectrometry.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis.

Generally, a mass spectrometer includes an ion source, an analyzer, and a detector. The ion source converts a test sample into gaseous ions, the mass analyzer separates (or mass analyzes) the gaseous ions based on their m/z ratios, and the detector detects the separated ions. One or more ion mass filters are often installed between the ion source and the analyzer to isolate the precursor ions. Further, one or more dissociation devices are often installed between mass filter and the analyzer to dissociate the isolated precursor ions for tandem mass spectrometry.

The full-scan mode of mass spectrometry (MS) of different types, such as time of flight scan mass spectrometry (TOF scan MS) or various types using quadrupoles (such as Q1 scan MS), etc., has been widely used in various applications. The full scan mode of MS greatly simplifies the MS method development, and enables not only analysis of the target species, but also identification of other ions present in the sample. The full scan mode has been utilized routinely for untargeted profiling, reaction optimization, compound QC, etc.

Since the information extraction relies on the full scan mass spectra, it would be critical to differentiate the ion signals of interest from the background ions, some of which may appear in mass spectra for multiple samples. Such differentiation is especially critical for the workflows requiring the analysis of non-targeted mass over charge (hereinafter called m/z) values. Examples of such workflows include full spectra profiling for pattern matching (e.g., in cancer diagnosis), purity assessment for the compound QC workflow, and by-product identifications for reaction optimizations.

### SUMMARY

Some embodiments relate to a method for determining a composition of a sample utilizing mass spectrometry, the method including: introducing into a mass spectrometer, via a sample introduction, a plurality of sample ions generated by ionizing at least a portion of analytes in the sample; obtaining, via the mass spectrometer, a plurality of mass spectra including a sample introduction mass spectrum associated with the sample introduction; analyzing the plurality of mass spectra to identify a set of background signals that are included in two or more of the plurality of mass spectra and correspond to a set of background ions; identifying, in the sample introduction mass spectrum, the set of background signals; identifying, in the sample introduction mass spectrum, a set of sample ion signals; and deriving, from the set of sample ion signals, an ion list corresponding to the composition of the sample.

Some embodiments relate to a method, further including removing the set of background signals from the sample introduction mass spectrum.

Some embodiments relate to a method, wherein the set of background signals include a first type background signal not associated with the sample introduction.

Some embodiments relate to a method, wherein the set of background signals include a second type background signal associated with the sample introduction.

Some embodiments relate to a method, wherein the second type background signal corresponds to a mobile phase associated with the sample.

Some embodiments relate to a method, wherein the second type background signal corresponds to a container of the sample.

Some embodiments relate to a method, further including deriving a set of characteristics of the sample from the ion list.

Some embodiments relate to a method, wherein the set of characteristics of the sample include a composition of the sample.

Some embodiments relate to a method, wherein the set of characteristics of the sample include a structure of the sample.

Some embodiments relate to a method, further including deriving a background ion list corresponding to the set of background ions.

Some embodiments relate to a method, wherein the mass spectrometer utilizes time of flight mass spectrometry.

Some embodiments relate to a method, wherein the sample introduction is performed via acoustic ejection.

Some embodiments relate to a method, further including excluding a set of signals that are below a threshold intensity from the sample introduction mass spectrum.

Some embodiments relate to a method for determining a composition of a sample utilizing mass spectrometry, the method including: ionizing one or more analytes in the sample to generate a plurality of ions, introducing the plurality of the ions into a mass spectrometer to generate a plurality of ion detection signals, identifying a first set of ion detection signals as corresponding to one or more background ion signals and a second set of ion detection signals as corresponding to one or more composition analyte signals, and utilizing the one or more composition analyte signals to generate a list of analytes present in the sample.

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 schematically depicts a mass spectrometry system 100 according to various embodiments.

FIGS. 2A-2C show 3 views of a section of a chronogram 200 of a mass spectrum as derived by a mass spectrometer according to an embodiment.

FIGS. 3A-3C show graphs of mass spectra 310, 340, and 370, respectively corresponding to chronogram ranges 225, 215, and 255 of chronogram 200, for the embodiments described in FIGS. 2A-2C.

FIG. 4 is an illustration of the spectra of target ions and background ions.

FIGS. 5A-5D respectively illustrate mass spectral graphs 510, 520, 530, and 540, used for sample and background ion detection according to some embodiments.

FIG. 6 illustrates a flowchart 600 for identifying sample and background ions according to some of the present embodiments.

FIG. 7 illustrates flowchart 700 for analysis of spectral data obtained from the mass analyzer.

FIG. 8 schematically depicts an example of an implementation of a module 800 according to some embodiments.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

The following detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

In this disclosure, the following terms may be used with the following corresponding definitions.

A sample introduction event (SIE) corresponds to one or multiple consecutive cycles of introducing a sample into a mass spectrometry system.

A sample data acquisition period (SDAP) corresponds to a time interval during which a mass spectrometer generates spectral data for ions that are generated from at least parts of a sample introduced into the mass spectrometry system.

A non-sample period, on the other hand, corresponds to a time interval that does not fall into a SDAP and during which a mass spectrometer generates one or more mass spectra (termed non-sample mass spectra) corresponding to ions that are not generated from a sample.

A sample mass spectrum corresponds to a mass spectrum or a combination of mass spectra obtained during a SDAP and, therefore, corresponding to a sample.

A target analyte corresponds to an analyte of interest in a sample for which, for example, the purity is determined. A non-target analyte, on the other hand, corresponds to an analyte in the sample that is different from the target analyte and may, therefore, be considered as part of the impurity in the sample. A target ion corresponds to an ion generated from a target analyte and a non-target ion corresponds to an ion generated from a non-target analyte.

Typically, there may exist more than one background ion or more than one type of background ion, each having multiple isotopes. These multiple ions and isotopes may define the background m/z intensity pattern.

In some cases, such as in an Echo® MS, there may exist two types of background mass spectra corresponding to two types of background ions. These two types could cause either false positives or false negatives in the analysis results. In this disclosure these two types are called type 1 and type 2, or equivalently first type and second type, and explained below.

The first type of background mass spectrum, resulting from a first type of background ions, may be sample independent; their appearances may be constant and not dependent on the introduction of a sample into a mass spectrometer for mass analysis. This type of background ions may originate in the mobile phase (carrier solvent), ion source, or system contaminations. The first type of background mass spectrum, therefore, may appear both in the non-sample period and in the SDAP. Compared to its level in the non-sample period, the level of the first type of background ion signal during the SDAP may be the same or different; the level may be different because, during sample introduction, this type of background spectra may be enhanced (e.g. due to the pH change of the sample) or suppressed (e.g., due to the ionization suppression from the sample matrix).

The second type of background mass spectra, on the other hand, may only be present during the detection of the sample ions, that is, during the SDAP. The corresponding second type of background ions that generate the second type of background mass spectra, therefore, may appear alongside the appearance of the sample ions. In some embodiments, these background ions may be generated when the sample ions are generated but they may not originate from the analytes in the sample, but instead originate from other compounds that are present alongside the sample analytes. For example, the second type of background ions may originate in the matrix of the sample solution (e.g. sample solvent) or in the container of the sample. This type of background signal may therefore have different intensities between the non-sample period and the SDAP. Moreover, the intensity of the second type background signal may be relatively constant for the samples from the same resource/assays, but may be different from batch to batch (e.g. samples dissolved in different lots of the solvents).

Some existing methods attempt to identify and subtract background spectra from the sample spectra. These methods, however, have many shortcomings.

One possible method is to determine the mass spectra not associated with sample introduction as an estimate of the type 1 background spectra. This method, however, cannot determine the type 2 background spectra. Moreover, even in its determination of the type 1 background, it may not compensate for the potential enhancement or suppression of the type 1 background during the SDAP. Therefore, by subtracting the measured background spectra from the full spectra (i.e., spectra containing spectral mass peaks corresponding to an analyte under analysis as well as background ions, if any), the traditional methods may derive erroneous values for the sample spectra. In addition, because in some high-throughput analysis systems (e.g. Echo MS), sample signals in the time domain are close to each other, the spectra may not provide a stable period of no sample introduction for extracting the background mass spectra with this method.

Another possible method would be to measure mass spectra of a separate “blank” sample to estimate both type 1 and type 2 backgrounds. This method also suffers from several shortcomings. To begin, this method requires additional time and effort for preparing and measuring the mass spectra of the blank sample. Moreover, this method poses the challenge of creating ideal blank samples for all workflows and assays, such that the blank sample is as identical as possible to the real sample. Furthermore, this method may not compensate for the potential background scale variations among different samples, which, for example, may result from the interaction of the background ions with the sample.

Some embodiments provide methods and systems for detecting quantitative spectra of background ions or separating those spectra. Further, some embodiments utilize the detection of the background spectra for quantitative detection of compounds of interest. Some embodiments perform these operations in an unsupervised automated manner. Some embodiments also provide methods and mechanisms for measuring uncertainty in the analysis.

Some embodiments determine the scale of the background ions, therefore enabling an accurate subtraction of the background spectra from the full spectra for determining the sample spectra in an accurate manner.

Some embodiments are used to extract both type 1 and type 2 background spectra and further derive the correct scale for the background spectra to be subtracted from the sample spectra.

Some embodiments are used to determine the background ions and their intensity scales for different types of ions and in different types of MS.

In Echo® MS, in which ultrasound energy is utilized to eject a sample into an open port interface of a mass analyzer, some or all of the background ions may have the same pattern across multiple wells.

The ions of interest, on the other hand, may be different or may have different m/z intensity patterns across different SIE's. In some cases, ions of interest may appear in a subset of SIE's.

In some cases, background ion patterns may change in unknown ways across SIEs. In some cases, background ions may preserve their m/z intensity patterns such that some or all background ions have the same intensity ratios between two SIE's.

Some embodiments utilize one or more of the following steps in determining estimates of the background spectra.

Some embodiments utilize a most likely ratio (MLR) method across two sampling events.

Some embodiments may extract different features from the MLR method as estimates for existence and intensities of background ions. These estimates may not depend on the type of the background ion. Further, the extracted features may provide estimates of the spectral intensity scaling factors for each sampling event.

In some embodiments, a scaling factor for a sampling event may be a ratio of the intensity of a background spectrum for that sampling event to that intensity for a reference sampling event.

Some embodiments enable quantitative detection of background intensity and deconvolution of the detected background spectrum from the spectrum of a compound of interest. This may be done even when the peaks for the two spectra overlap completely or partially, and therefore the background contribution changes the shape or the intensity of the m/z peak of ions of interest.

Some embodiments provide a qualitative analysis of compounds of interest by subtracting scaled representative background spectra from sampling event spectra to detect ions of interest.

Some embodiments provide a quantitative analysis by determining the contribution of a background ion to a peak related to an ion of interest.

Some embodiments create an ion spectral library by subtracting the background before adding the spectrum to the spectral library.

Some embodiments incorporate the derived information about the background spectrum into the spectral library.

Some embodiments enable searching the spectrum library by using a background subtracted spectrum to achieve library matching.

Some embodiments utilize the derived sample related peaks to determine time dependent values of compound purity, degradation, fragmentation, or adduction.

Some embodiments utilize the derived data to estimate a spectral quality by, for example, comparing intensities of ions of interest against background ions or comparing spectra between two libraries to create workflows such as compound quality control (QC).

Some embodiments perform compound QC workflow, by comparing the background subtracted mass spectra against some reference spectra, or by comparing across two sets of spectra from two libraries.

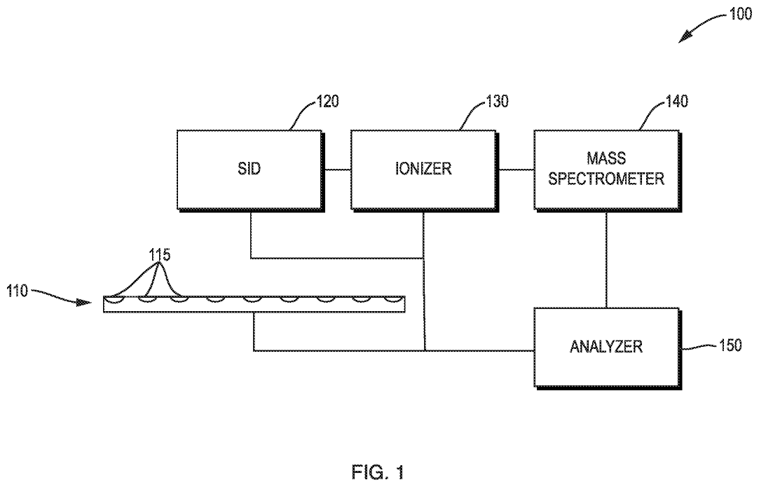

FIG. 1 schematically depicts a mass spectrometry system 100 according to various embodiments. Mass spectrometry system 100 includes a sample holder 110, a sample introducer 120, an ionizer 130, a mass spectrometer 140, and an analyzer module 150.

Sample holder 110 may be implemented as a device that includes a plurality of reservoirs 115. In some embodiments, each reservoir 115 may be a well in which one or more samples are stored. In some embodiments, each reservoir 115 stores one type of sample but different reservoirs may store different types of samples.

Sample introducer 120 may be a device that is configured to extract at least part of one or more samples from sample holder 110 (for example, from one or more of reservoirs 115) and deliver part or all of the extracted sample to ionizer 130. In some embodiments, sample introducer 120 may be an ejection system that utilizes one or more of different sources of energy for detaching samples from sample holder 110. Examples of those sources of energy include acoustic pulses, pneumatic pressure, heat, charged solvent droplet impact, laser heating, or another source of thermal energy.

Some embodiments may further include an optional sampling interface positioned between sample introducer 120 and ionizer 130. The sampling interface may, for example, receive and dilute the sample from sample introducer 120 before the sample is sent to the ionizer. In various embodiments, the sampling interface may be an Open-Port Interface (OPI) used in the Acoustic Ejection Mass Spectrometry (AEMS) technology. The OPI may, for example, receive a sample extracted from a reservoir, e.g., ejected via acoustic ejection, dilute the received sample, and transfer the sample to a downstream ionizer.

Ionizer 130 may be configured to ionize at least part of the sample that the ionizer receives, and generate a plurality of sample ions from the analytes in the received sample. Ionizer 130 may deliver those sample ions to spectrometer 140 for data collection during a SDAP.

Mass spectrometer 140 is configured to receive the sample ions generated by ionizer 130, and detect those ions or their fragments. More specifically, mass spectrometer 140 may perform multiple mass spectral scans over the received sample ions and generate a mass spectrum for each of the scans, as further detailed below. The mass spectrum may reflect the relative number of different ions in the received sample ions. In various embodiments, a mass spectral scan may include scanning over a range of m/z values by the mass spectrometer.

In some embodiments, mass spectrometer 140 may receive sample ions from one or more samples in one or more sample introductions and, for each sample introduction, the mass spectrometer may perform one or more spectral scans. Therefore, each SDAP may on the one hand be associated with a sample and on the other hand with one or more mass spectra each obtained by a mass spectral scans performed within that SDAP, namely one or more sample mass spectra

In various embodiments mass spectrometer 140 may perform repeated mass spectral scans. Some mass spectral scans may be performed during a non-sample period and therefore provide mass spectra that do not include sample ion signals. These mass spectra, however, may include background ion signals, and in particular, background ion signals that may correspond to type one background ions, as explained above.

Some other mass spectral scans, on the other hand, may be performed during a SDAP and therefore provide mass spectra that include sample ion signals. These mass spectra may also include background ion signals corresponding to both types of background ions, as also explained above.

In various embodiments, the mass spectrometer may include various types of mass spectrometer instruments such as a quadrupole mass spectrometer, a time-of-flight (ToF) mass spectrometer, an ion trap mass spectrometer, a triple quadrupole mass spectrometer, a hybrid instrument including QToF or trapping instruments, such as a linear ion trap, a 3d ion trap, an Orbitrap, an electrostatic ion trap, or a combination of these with one another, or with other types of mass spectrometers.

In some embodiments, mass spectrometer 140 may include an MS/MS mass spectrometer configured to perform MS/MS analysis of the sample ions that it receives. In such embodiments, the mass spectrometer may include a mass filter that is configured to select one or more precursor ions, and a collision cell to fragment the selected precursor ions. These fragments are then detected by an ion detector of the mass spectrometer to generate ion detection signals that may then be processed to generate a mass spectrum of the fragment ions.

Returning to system 100 of FIG. 1, analyzer module 150 may be a module configured to receive and analyze data from one or more other parts of mass spectrometry system 100. In particular, analyzer module 150 may receive one or more mass spectral data from mass spectrometer 140 and analyze those data to determine one or more characteristics of one or more of the samples. Those characteristics may include, for example, the composition and structure of one or more analytes that are present in a sample. Moreover, as further detailed below, analyzer module 150 may also derive other information that may not be directly related to a sample, such as information about background ions originating from the environment, instruments, medium, etc.

In some embodiments, analyzer module 150 may send back to spectrometer 140 data corresponding to the derived background spectra. Spectrometer 140 may utilize these background spectra in its subsequent spectral scans to, for example, exclude one or more of the background ions from the MS. An example of these embodiments is the IDA mode. As a result, even high intensity background ions may be excluded as they are not ions of interest.

The mass spectral data collected by mass spectrometer 140 may include information related to different dimensions of the measurements performed by mass spectrometer 140, such as time, intensity, and mass (or more precisely mass to charge ratio or m/z). As a result, the mass spectral data may be presented or analyzed along different dimensions.

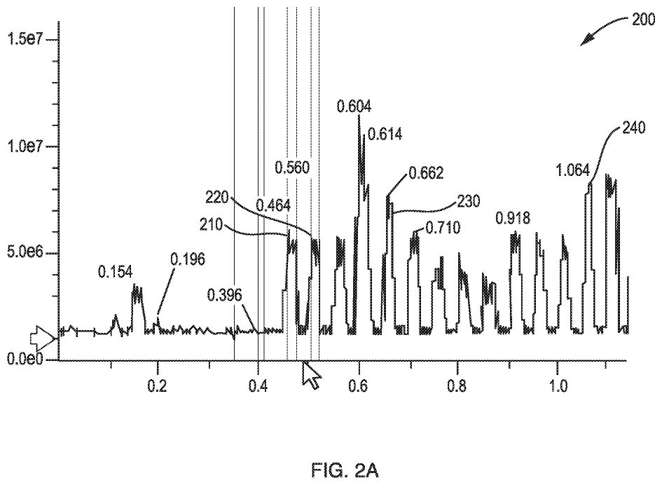

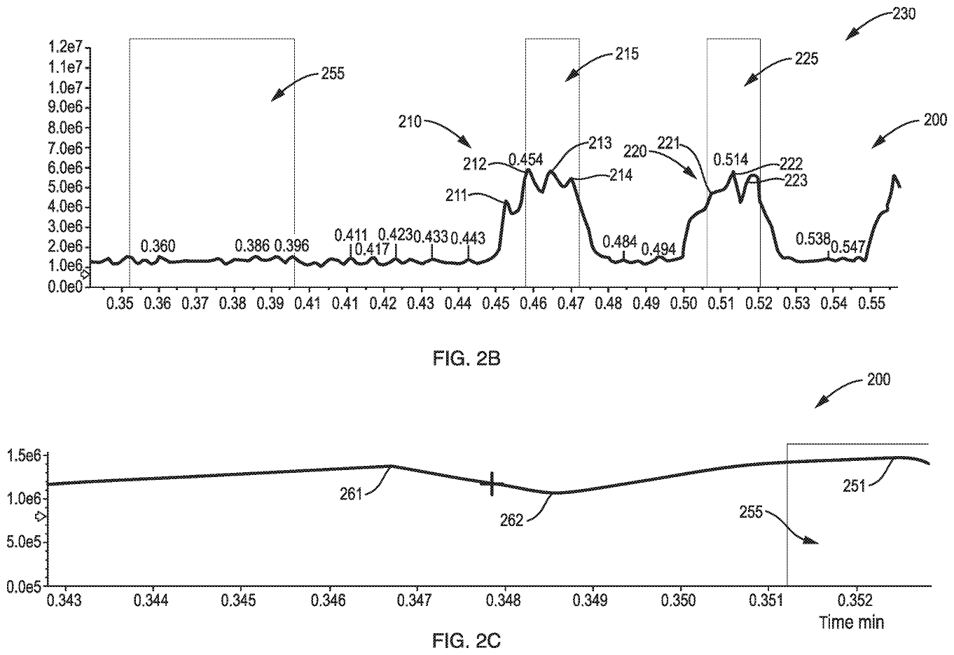

FIGS. 2A-2C show 3 views of a section of a chronogram 200 of a mass spectrum as derived by a mass spectrometer according to an embodiment. A chronogram presents the mass spectral data in the form of intensity of the detected ions as a function of time, as further detailed below.

Chronogram 200 shows a graph of the mass spectral data in the form of intensity of the detected ions as a function of time. More specifically, the Y axis depicts the intensity of the detected ions measured in counts per second (cps). The X axis, on the other hand, depicts the time of the detection of those ions measured in minutes and with respect to an arbitrary starting time, e.g., the start of one round of measurements. In some embodiments, the Y axis in the chronogram may be either the total intensity of all ions measured at a point in time (TIC), or a specific mass range (XIC). Chronogram 200, for example, corresponds to TIC.

Chronogram 200 includes multiple chronogram peaks such as chronogram peaks 210, 220, 230, and 240. Each chronogram peak may correspond to the detection of ions received by the mass spectrometer from an ionizer. Therefore, the one or more mass spectra that may be derived from each chronogram peak may correspond to one sample mass spectrum.

More specifically, Chronogram 200 includes multiple chronogram data points such as data points 211-214, 221-223, 251, 261, and 262. Each data point may correspond to a spectral scan at the corresponding time. Therefore, the chronogram may be generated by connecting the data points, and thus some data points may be recognized as those points on the chronograph at which the slope changes. While in chronogram 200 the above-listed data points have been labeled, the chronograph includes many more data points, some of which may be located between two consecutively labeled data points.

Chronogram 200 further depicts chronogram ranges 215, 225, and 255. A chronogram range may be defined by the analyzer or by a user through, for example, selecting a range of time on a graphical interface showing the chronogram. In some embodiments, after a chronogram range is defined, the analyzer averages the mass spectra that are obtained in that range and presents that average as the mass spectrum for the range. Chronogram ranges 215 and 225 respectively cover a range of time included in chronogram peaks 210 and 220, each corresponding to a SDAP. Therefore, the mass spectrum derived for each of chronogram ranges 215 and 225 corresponds to a sample mass spectrum. Chronogram range 255, on the other hand, is located outside any SDAP, that is, located in a non-sample period. Therefore, ions detected by the corresponding mass spectra may be associated with non-sample ions, for example, background ions.

Returning to the description of the above-listed data points, data points 211-214 are located inside chronogram peak 210, inside the same SDAP. Therefore, the mass spectra derived from data points 211-214 may correspond to four sample mass spectra associated with one sample to which chronogram peaks 210 corresponds. Similarly, data points 221-223 may correspond to three sample mass spectra associated with a sample to which chronogram peak 220 corresponds. In some embodiments, different chronogram peaks or different SDAPs correspond to introductions of different samples.

Data points 251, 261, and 262, on the other hand, are not associated with any SDAP. Instead, each of them is located in a non-sample period and, therefore, the mass spectrum obtained at each of these data points corresponds to a non-sample mass spectrum.

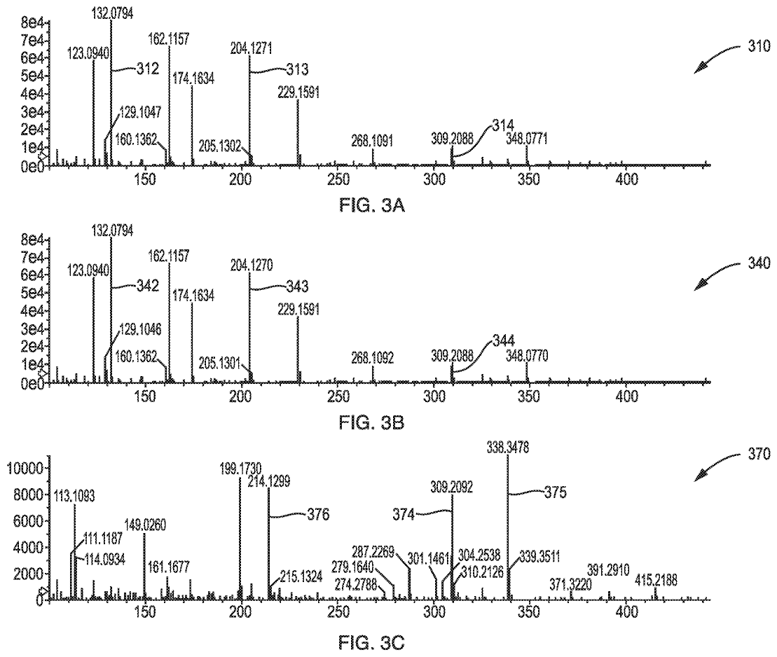

FIGS. 3A-3C show three mass spectral graphs 310, 340, and 370, respectively corresponding to chronogram ranges 225, 215, and 255 of chronogram 200 described in FIGS. 2A-2C. Therefore, as explained above, mass spectral graphs 310 and 340 correspond to two sample mass spectra (related to two consecutive SDAPs) while mass spectral graph 370 corresponds to a non-sample mass spectrum associated with a non-sample period.

Each mass spectral graph shows the mass spectral data in the form of intensity of the detected ions on the y-axis (measured in cps) as a function of m/z of the detected ions on the x-axis (measured in Daltons). More specifically, each mass spectral graph includes multiple mass spectral peaks. For example, mass spectral graph 310 includes multiple mass spectral peaks among which mass spectral peaks 312-314 are labeled; mass spectral graph 340 includes multiple mass spectral peaks among which mass spectral peaks 342-344 are labeled; and mass spectral graph 370 includes multiple mass spectral peaks among which mass spectral peaks 374-376 are labeled.

Different mass spectral graphs may include peaks at the same m/z value, which may indicate that the two mass spectra have detected the same ion. This common ion may originate from a sample analyte ion or a background ion that existed in both sets of ions detected by the two mass spectra.

In particular, most of the peaks in the two sample mass spectra 310 and 340 indicate the detection of the same analyte ions by the two mass spectra. For example, mass spectral peak 312 of mass spectrum 310 and the ion 342 of mass spectrum 340 both have an m/z value of 132.0794 Daltons. Therefore mass spectral peaks 312 and 342, both of which correspond to sample mass spectra, should indicate the detection of the same sample analyte by both mass spectra. Similarly, mass spectral peaks 313 and 343 should indicate the detection of another common sample analyte for which the detected ion has an m/z value of about 204.127 Daltons. Noteworthy is that the intensity of the common ions (indicated by the y-axis value of the corresponding peaks) is the same in the two mass spectra, that is, an intensity around 80,000 cps for the sample analyte ion detected by mass spectral peaks 312 and 342, and an intensity around 70,000 cps for the sample analyte ion detected by mass spectral peaks 313 and 343.

Comparing the two sample mass spectra 310 and 340 with the non-sample mass spectrum 370 further reveals existence of some ions in all three. Because of their existence in the non-sample mass spectrum, such ions may correspond to background ions. For example, the common m/z value of around 309.209 Daltons for mass spectral peaks 314, 344, and 374 may indicate the detection of the same background ion with that common m/z value by the three mass spectra. For this background ion, similar to the two previously discussed sample analyte ions, the intensities of the peaks in the three mass spectra around the same value of about 8000 cps (which is around one tenth of the intensities of the discussed sample analyte ions). On the other hand, some other ions in non-sample mass spectrum 370, such as 375 and 376, do not appear in the two sample mass spectra 310 and 340, indicating that they may correspond to background ions that were detected in chronogram range 255 but not in chronogram range 215 or chronogram range 225. Signal levels for these two background ions may have been suppressed in the SDAP.

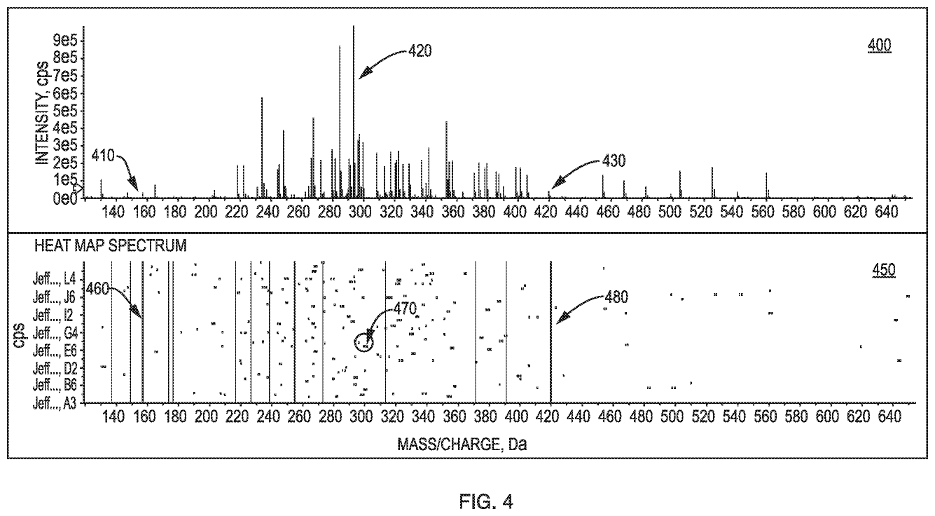

FIG. 4 is an illustration of the spectra of sample ions and background ions. As shown in the figure, there are some differences between the sample ions and the background ions. In particular, FIG. 4 shows two plots of MS data according to some embodiments. The top plot is the overlap of mass spectra from multiple samples. Similarly, the bottom plot is a heat map 450 derived from an overlap of multiple samples full scan MS data as further explained below.

The full scan MS data may include the MS data corresponding to plot 400. Spectral plot 400 illustrates intensities of mass spectra for a number of ions observed in a full scan MS run. More specifically, the X axis in this plot shows the values of m/z for ions in units of Dalton. The Y axis shows the intensity of the spectra observed for each value of m/z in units of counts per second (cps).

As seen in plot 400, the corresponding full scan MS has detected spectra for many ions in the form of many peaks of different intensities. In plot 400, three of those peaks have been labeled peaks 410, 420, and 430, for further illustration and description. These peaks indicate the existence of three ions. Peak 410 corresponds to an ion with an m/z value around 160 Daltons and an intensity less than 0.5×10⁵ cps. Similarly, peaks 420 and 430 correspond to ions with m/z values around 300 and 420 Daltons respectively, and intensities around 0.5×10⁵ and 0.5×10⁵ cps, respectively.

Heat map 450 indicates ions detected in the full scan MS data and their intensities. More specifically, the abscissa shows the m/z values for the detected ions. As may be seen from FIG. 4, the m/z values in plot 400 and heat map 450 are the same. The y coordinate of heat map 450, on the other hand, lists the plurality of full scan MS by some discrete variable, such as an identification for each scan. For each ion detected in an MS run, the heat map includes the dot at the corresponding m/z value on the X axis and the corresponding run on the Y axis. For the ions that were detected in many runs, the corresponding dots are connected to form a vertical line. Therefore, lines 460 and 480, for example, indicate that the ions corresponding to ions 410 and 430 have been detected in many MS runs. The ion corresponding to the high intensity ion 420, on the other hand, has appeared in at most a few runs such as the one circled and labeled 470.

In some embodiments, recurring appearance of an ion, such as those corresponding to peaks 410 and 430, may indicate that they may correspond to a background ion that is common among different MS runs. Ions such as the one corresponding to peak 420, on the other hand, which may appear with high intensities but not recurringly, may correspond to sample-specific ions. A sample-specific ion, may be a target ion or a sample-specific impurity.

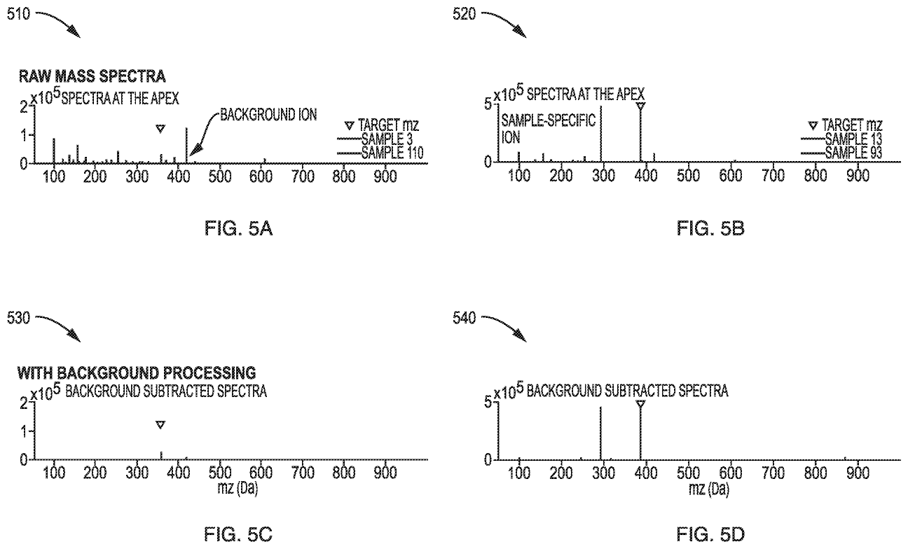

FIGS. 5A-5D respectively illustrate mass spectral graphs 510, 520, 530, and 540, used for sample and background ion detection according to some embodiments. In these graphs, on the x axis, the m/z of the ions is shown in units of Dalton. On the y axis, the count at each specific m/z value is shown in units of 105 cps.

Mass spectral graphs 510 and 520 illustrate two raw spectral data. Mass spectral graphs 530 and 540, on the other hand, illustrate the same two graphs, respectively, after subtraction of the mass spectral peaks corresponding to the background ions. The subtracted background ions may correspond to one or both types of background ions.

As illustrated in mass spectral graphs 530 and 540, a limited number of peaks may survive the background subtraction process. In mass spectral graph 530, for example, only one mass spectral peak, marked by an arrow and located at m/z around 350 Da, has survived the background identification and subtraction. This mass spectral peak may correspond to a sample ion and, more specifically, to a target ion, namely an ion of the target analyte. In mass spectral graph 540, on the other hand, two mass spectral peaks, located at m/z values around 300 Da and 400 Da, have remained after the background identification and subtraction. Of these two peaks, the second one (marked by an arrow) may correspond to a target ion, while the first one may correspond to a non-target ion, namely an ion of a non-target analyte in the sample that may be considered an impurity.

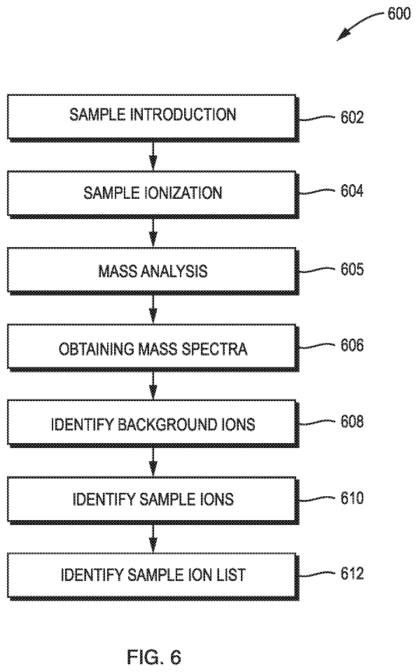

FIG. 6 illustrates flowchart 600 for identifying sample and background ions according to some of the present embodiments. In some embodiments, method 600 may be performed by a mass spectrometry system such as mass spectrometry system 100, or by one or more parts of such a system, such as the mass spectrometer or the analyzer module, as detailed below.

At step 602 a sample is introduced into an MS system. At step 604, the sample is ionized. At step 605 a mass analysis of the ions is performed. At step 606 the mass spectra from the MS analysis are obtained. At step 608 background ions are identified. At step 610 the sample ions are identified. At step 612 a sample ion list is obtained.

In flowchart 600, at step 602 a sample is introduced into an MS system for analysis according to some embodiments. The sample introduction is performed during a specific period and may be repeated in a similar fashion during specific time intervals. These time intervals, corresponding to sample data acquisition periods, are important in identifying sample and background ions as will be described below.

At step 604, the sample is ionized, and a number of sample ions are produced. The sample ionization may be performed with a dedicated ionizer according to some embodiments. In some embodiments the steps of 602 and 604 may be performed in the same components. An example MS system implementation of such embodiments may be a ESI or MALDI system.

At step 605 a mass analysis of the ions is performed. In some embodiments the mass analysis is a continuous run that measures m/z of all ions present in and detected by the mass analyzer with a specific count. This may incudes ions associated with a sample data acquisition period or ions that are not associated with the sample data acquisition period.

At step 606 the mass spectra from the MS analysis are obtained. The spectra include sample ions, type 1 background ions, and type 2 background ions. The sample ions and the type 2 background ions are associated with a sample data acquisition period. These ions are identified in a mass analyzer during a period that is associated with a sample period. For example, there may be a time delay between a sample ejection period in an acoustic ejection system, including the ejection and sample propagation time, the ionization and ion propagation time, and finally the acquisition time in a mass analyzer. In some embodiments, this time delay may be specified by using calibration runs with very specific ions.

The type 1 background ions are not associated with a specific sample data acquisition period. In the case of type 1 background ions, the system acquires the spectra during a period that may not be traced back to or associated with a sample data acquisition period. Accordingly, type 1 background ions may appear during any period including during or outside the sample data acquisition periods, but maybe with different intensities.

At step 608, background ions are identified. Identification of background ions includes both types of backgrounds. For type 1 background ions, which are not associated with a sample data acquisition period, all the ions detected during such periods are considered type 1 background ions. For type 2 background ions, which are associated with a data acquisition period, the detection is a more complex procedure, and it depends on the specific factors such as the knowledge of the sample and impurities, knowledge of a specific well from which the sample was obtained, and cross calibration of other runs or sample data acquisition periods as explained in more details below.

At steps 610 and 612, the sample ions are identified and a sample ion list is obtained. After subtracting the type 1 and type 2 spectra, the sample ions are identified to belong to the sample and to the particular well that the sample is introduced via ejection or other modes of sample extraction from a particular well. The list of sample ions is therefore dependent on a particular well in these embodiments.

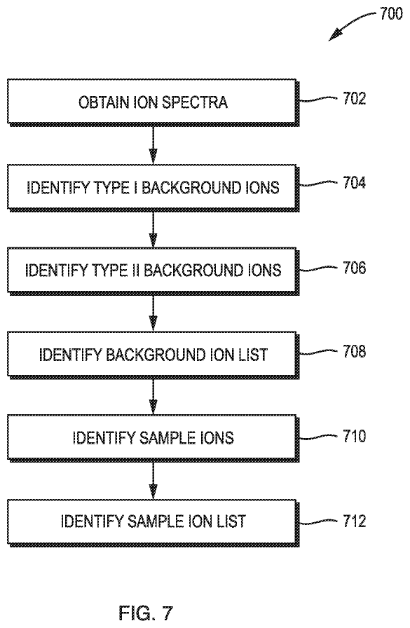

FIG. 7 illustrates flowchart 700 for analysis of spectral data obtained from the mass analyzer. In some embodiments, method 700 may be performed by a mass spectrometry system such as mass spectrometry system 100, or by one or more parts of such a system, such as the mass spectrometer or the analyzer module, as detailed below.

At step 702, ion spectra are obtained. At step 704, type I (type 1) background ions are identified. At step 706, type II (type 2) background ions are identified. In some embodiments these two backgrounds may not be differentiated and are identified collectively. In such embodiments, steps 704 and 706 constitute a single step. At step 708, a list of background ions is identified. At step 710, sample ions are identified. At step 712, a list of sample ions is identified.

In flowchart 700, at step 702 spectral data are obtained from the mass analyzer. The data indicates counts of various ions at a specific m/z value for a range of m/z values as discussed above. Any suitable mass analyzer may be used to generate such data such as TOF, ion trap, Orbitrap, etc. The data includes background ions of different sources and sample ions indicating an ion of interest originating from a sample analyte.

At steps 704 and 706, two types of background, namely type 1 and type 2 background ions, are identified. In some embodiments, since the MS runs continually acquire data, some of the background ions, namely type 1 background ions, are not associated with a sample data acquisition period and may occur during sample data acquisition as well as outside of sample data acquisition periods. Accordingly, peaks of sample ions are not expected to appear in time periods not associated with a sample data acquisition period.

Possible exceptions may be any residual ion from a previous sample data acquisition period, however, such residual ions should not constitute a high count.

At step 706, type 2 backgrounds are identified. Type 2 background ions are associated with a sample data acquisition period but are different from the sample ions, and as such, do not represent an analyte of interest.

Since these type 2 background ions are a result of sample introduction, they could belong to several categories. Various sources of type 2 background ions were discussed above.

In some embodiments, since type 2 background ions may originate from a specific sample or specific well, in some embodiments, separate lists of background ions are prepared for different samples or containers, or wells. In such embodiments, each well may have its own list of type 2 background ions.

In some embodiments, type 1 and type 2 backgrounds could not be differentiated. An example of these embodiments is shown in FIG. 4 and FIGS. 5A-5D, as discussed above.

In some embodiments, type 1 background ions are identified before the type 2 background background ions. One benefit of such embodiments is the fact that type 1 background ions may be present along with ions associated with a sample data acquisition period, and a sample data acquisition period may not suppress the generation of type 1 background ions. Accordingly, in these embodiments, type 2 background ions are identified after identifying and subtracting type 1 background ions to ensure that the type 2 background ions are indeed associated with a sample data acquisition period.

At step 708, a list of all the background ions, including type 1 and type 2 background ions, is accordingly identified and produced. This list includes all the ions identified in steps 704 and 706.

At step 710, sample ions are identified. These are ions that belong to an analyte of interest in the sample. The identification of the sample ions is contingent upon identifying and subtracting all the background ions according to the list of all background ions prepared at step 708.

At step 712, a list of sample ions is prepared which includes all the ions of interest originating from a sample analyte.

In various embodiments, one or more of disclosed modules may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud”, to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory. Further, in various embodiments, one or more of the storage media may be non-transitory computer-readable media that store data or computer programs executed by various modules, or implement various techniques or flow charts disclosed herein.

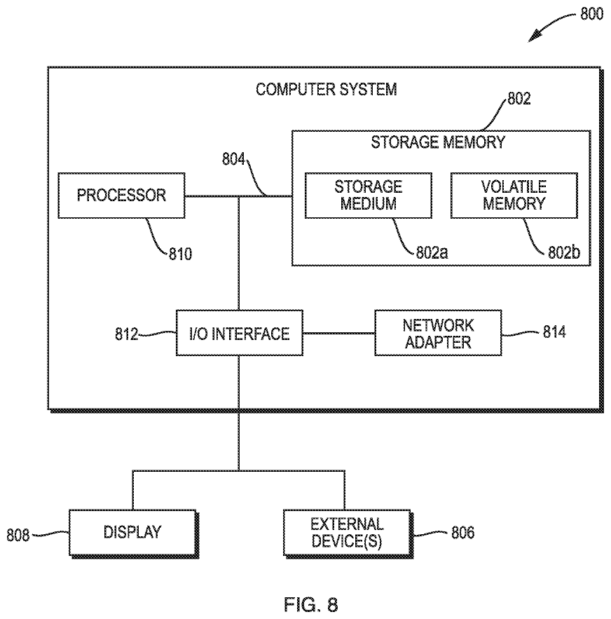

By way of example, FIG. 8 schematically depicts an example of an implementation of a module 800 according to some embodiments. Module 800 includes a system memory 802 that may include a permanent memory module (e.g., ROM 802a) and a transient memory module (e.g., RAM 802b), an internal bus 804, a processor 810 (e.g., a microprocessor), an I/O interface 812, and a communication interface 814 (such as a network adapter). I/O interface 812 may be in communication with one or more external input devices 806 (such as a mouse, a keyboard, or a touch screen) or output devices 808 (such as a display, a printer, or a speaker).

Processor 810 and the system memory 802 may be utilized to store and execute instructions performing the function of module 800. Moreover, internal bus 804 may enable communication between the processor and other parts of module 800 such as system memory 802, I/O interface 812, or communication interface 814.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the disclosure may be implemented in hardware and/or in software. The implementation may be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill will appreciate that various changes may be made to the above embodiments without departing from the scope of the disclosure.

Although some aspects have been described in the context of a system or an apparatus, it is clear that these aspects may also represent a description of the corresponding method, where a block or device corresponds to a method step or a feature of a method step. Analogously, aspects described in the context of a method step also represent a description of a corresponding block or item or feature of a corresponding apparatus.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or.

Moreover, if these terms are used, a set may include one or more members, and a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed compositions, systems, methods, and apparatus are not limited to any specific aspect or feature or combinations thereof, nor do the disclosed compositions, systems, methods, and apparatus require that any one or more specific advantages be present or problems be solved. Any theories of operation are to facilitate explanation, but the disclosed compositions, systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

1. A method for determining a composition of a sample utilizing mass spectrometry, the method comprising:
introducing into a mass spectrometer, via a sample introduction, a plurality of sample ions generated by ionizing at least a portion of analytes in the sample;
obtaining, via the mass spectrometer, a plurality of mass spectra including a sample mass spectrum associated with the sample introduction;
analyzing the plurality of mass spectra to identify a set of background signals that are included in two or more of the plurality of mass spectra and correspond to a set of background ions;
identifying, in the sample introduction mass spectrum, the set of background signals;
identifying, in the sample introduction mass spectrum, a set of sample ion signals; and
deriving, from the set of sample ion signals, an ion list corresponding to the composition of the sample.

2. The method of claim 1, further comprising removing the set of background signals from the sample introduction mass spectrum.

3. The method of claim 1, wherein the set of background signals includes a first type background signal not associated with the sample introduction.

4. The method of claim 1, wherein the set of background signals includes a second type background signal associated with the sample introduction.

5. The method of claim 4, wherein the second type background signal corresponds to a mobile phase associated with the sample.

6. The method of claim 1, wherein the second type background signal corresponds to a container of the sample.

7. The method of claim 1, further comprising deriving a set of characteristics of the sample from the ion list.

8. The method of claim 7, wherein the set of characteristics of the sample include a composition of the sample.

9. The method of claim 7, wherein the set of characteristics of the sample include a structure of the sample.

10. The method of claim 1, further comprising deriving a background ion list corresponding to the set of background ions.

11. The method of claim 1, wherein the mass spectrometer utilizes time of flight mass spectrometry.

12. The method of claim 1, wherein the sample introduction is performed via acoustic ejection.

13. The method of claim 1, further comprising excluding a set of signals that are below a threshold intensity from the sample mass spectrum.

14. A method for determining a composition of a sample utilizing mass spectrometry, the method comprising:
ionizing one or more analytes in the sample to generate a plurality of ions,
introducing the plurality of the ions into a mass spectrometer to generate a plurality of ion detection signals,
identifying a first set of ion detection signals as corresponding to one or more background ion signals and a second set of ion detection signals as corresponding to one or more composition analyte signals, and
utilizing the one or more composition analyte signals to generate a list of analytes present in the sample.
